(19) United States
(12) Patent Application Publication
(10) Pub. No.: US 2004/0019699 A1
(43) Pub. Date: Jan. 29, 2004

(54) On-line system for website transforming and method thereof

(76) Inventors: Xi-Nam Dam, Dalian (CN); Hong-Wei Bi, Dalian (CN); Brown Duan, Dalian (CN)

Correspondence Address: BIRCH STEWART KOLASCH & BIRCH, PO BOX 747, FALLS CHURCH, VA, 22040-0747, US

(21) Appl. No.: 10/270,350

(22) Filed: Oct. 15, 2002

(30) Foreign Application Priority Data
Jul. 26, 2002 (TW) 91116796

(51) Int. Cl. G06F 15/16

(52) U.S. Cl. 709/246

(57) ABSTRACT

An on-line system for website transforming and method thereof are disclosed. By establishing varied website and web page patterns and complete editing rules, the user is able to make immediate and full changes in the original website through a network. It makes the subsequent website maintenance more convenient, the website content changes more flexible, and offers more varieties for the website contents.

### BACKGROUND OF THE INVENTION

1. Field of Invention

The invention relates to a network application service system and the method thereof. In particular, the invention allows the user to use the disclosed website conversion patterns and conversion rules to make website conversions.

2. Related Art

As the Internet prospers, the number of websites grows expentially. Consequently, the website contents maintenance also becomes more important and often.

In the past, the website contents maintenance is usually done by professional technicians using special utilities. Since the website contents maintenance is normally very complicated, it does not only cause much trouble for the user but is also very time-consuming. This is particularly true when there are too many websites that need maintenance but are located at many different distant servers. Such a task is indeed a big burden for the user. To accomplish the job of website maintenance, the user usually has to possess vairous kinds of professional skills. It is therefore almost impossible for those without any technical computer knowledge to do the job. This inevitably forms a high threshold and big obstacle in performing such tasks.

As more advanced hardware and software technologies become available, it is an important issue to find a way to fully utilize the convenience of network systems and related hardware and software techniques so that the website conversion mechanism can be made easy. It is highly desirable for the user to be able to readily make website conversions and to centralize the management. Through varied pattern assistance, the website contents can be updated, modified and expanded at any time. This will make the provided network services more attractive.

### SUMMARY OF THE INVENTION

In view of the foregoing, the invention provides an on-line assisting website conversion system and method. A primary objective of the invention is to allow users to quickly and conveniently perform website conversion operations on line with the help of website and web page patterns and conversion rules. Therefore, the website management and maintenance become much easier, while the website changes and contents are more varied.

### BRIEF DESCRIPTION OF THE DRAWINGS

The invention will become more fully understood from the detailed description given hereinbelow illustration only, and thus are not limitative of the present invention, and wherein:

FIG. 1 shows the operation structure of the disclosed on-line system for website transforming and method thereof;

FIG. 2 is an operation flowchart of the disclosed on-line system for website transforming and method thereof;

FIG. 2-a shows a flowchart of step A in FIG. 2; and

FIG. 2-b shows a flowchart of step B in FIG. 2.

### DETAILED DESCRIPTION OF THE INVENTION

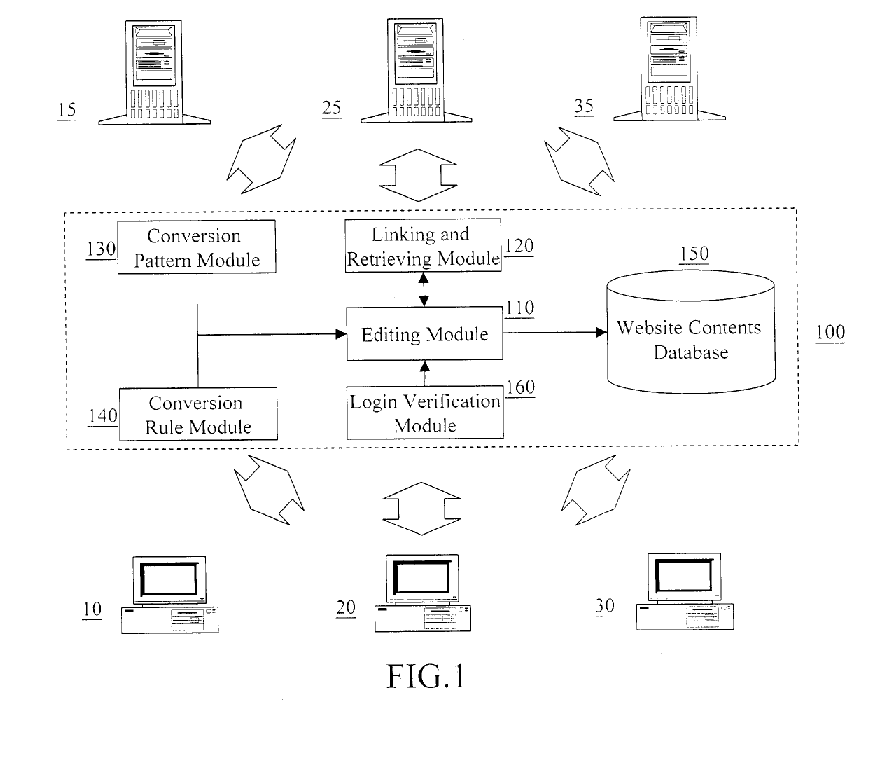

The disclosed on-line system for website transforming and method thereof enable a user to use a browser on an operating terminal (such as the operating terminal A 10, operating terminal B 20, and operating terminal C 30 in FIG. 1) to connect to the system 100. The original website content is extracted from a distant server (e.g. distant server A 15, distant server B 25, and distant server C 35 in FIG. 1). The website conversion operation is performed using a universal editing window provided by the invention. The website conversion operation refers the conversion from the original website content built by the user into a new website structure and the associated web page contents according to the provided assisting patterns along with the conversion rules. This helps the user for future management and maintenance and makes the websites thus produce more flexible and compatible.

The main operation structure of the invention is shown in FIG. 1. Each operating terminal is linked to the asociated distant server (e.g. the operating terminal A 10 corresponding to the distant server A 15). Of course, the operating terminals and the distant servers can be completely independent. Since the website conversion system 100 involves the core techniques of the invention, we describe it in detail as follows. The system 100 has an editing module 110, a linking and retrieving module 120, a conversion pattern module 130, a conversion rules module 140, and a website contents database 150.

(1) The editing module 110 provides an editing window for the user to make various operations and selections for website conversions. Such operations include the selections of editing content forms (e.g. website structure conversion and web page contents conversion), original website contents to be converted, conversion patterns to be used (e.g. website structure patterns and web page content patterns), and editing rules to apply. The editing rules are mainly some system program processing rules, which informs the disclosed website conversion system 100 how to convert the texts, pictures and tables in the user selected original website contents into the user selected new website and/or web page patterns.

(2) The linking and retrieving module 120 accesses data according to a link provided by the user. Such data include verification and authorization data (e.g. user names and passwords) and path data (i.e. the directory path that stores the original website contents). It automatically links to each distant server to retrieve the corresponding original website content.

(3) The conversion pattern module 130 provides conversion patterns (including website structure patterns and web page content patterns) for making website and web page content conversions. The pattern expansion and updating can also be done at any time using the module 130.

(4) The conversion rule module 140 provides editing rules for website and web page content conversions. The module 140 also makes adjustments, expansions, and settings according to different patterns or user requests.

(5) The website contents database 150 stores converted website contents. Afterwards, the website contents can be access at the database 150 for providing World Wide Web (WWW) network services.

In fact, to ensure the cyber security, the disclosed website conversion system 100 further has a login verification module 160. When the user links from an operating terminal, the login verification procedure asks the user to login. Only authorized users can enter the disclosed website conversion system 100 to perform various operations.

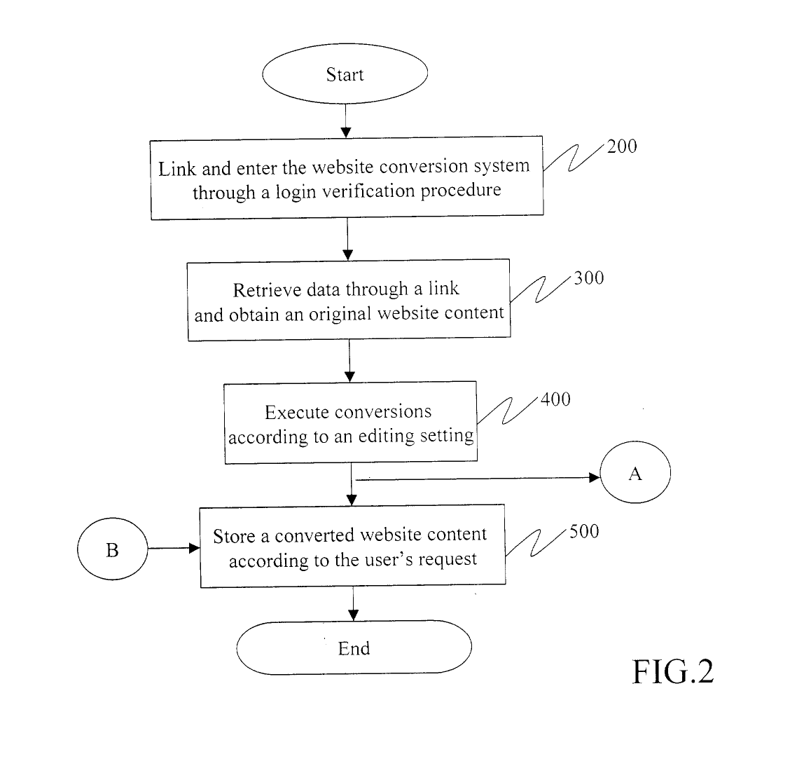

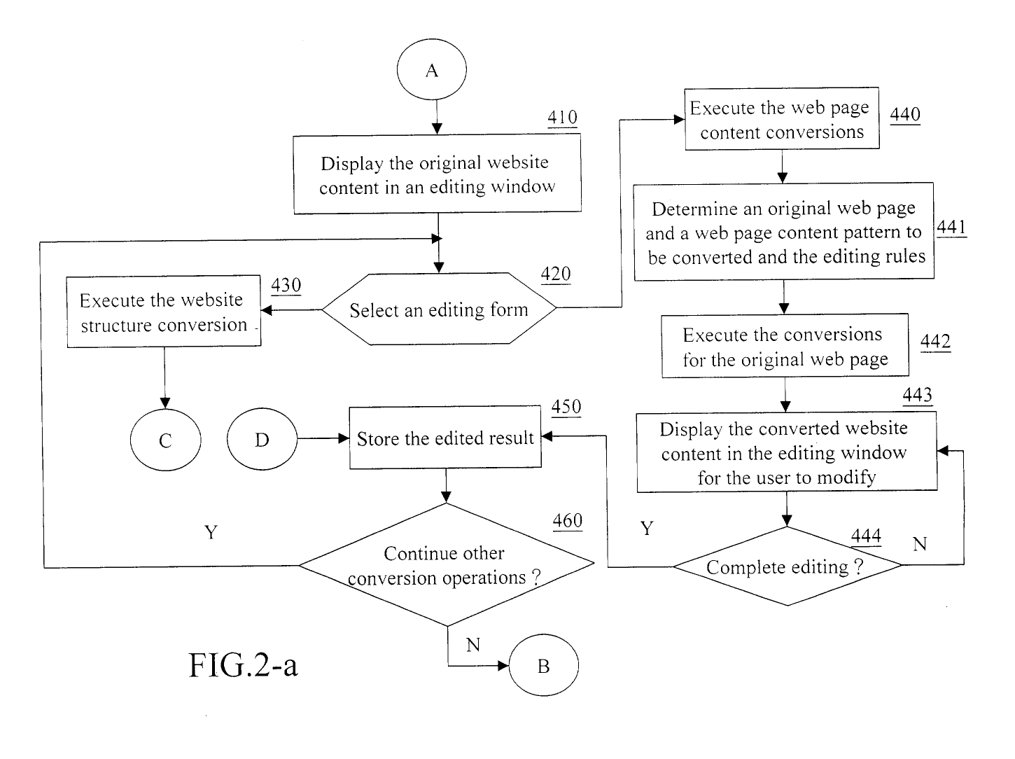

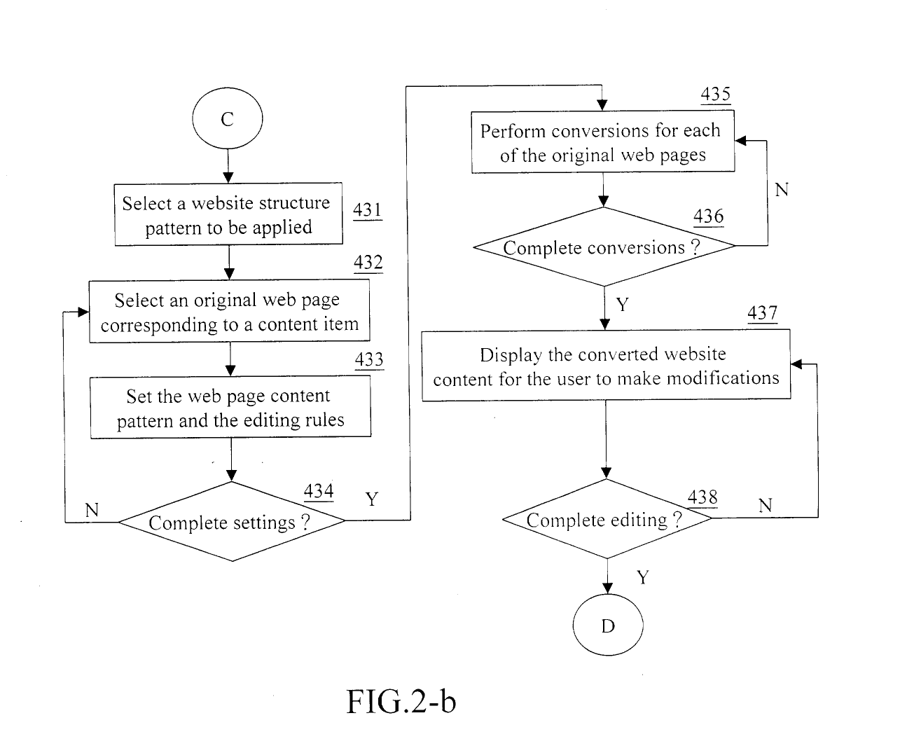

We use FIGS. 2, 2-a, and 2-b to explain the operation procedure of the invention. In the beginning, the user links and enters the disclosed website conversion system 100 through a login verification procedure from an operating terminal (e.g. the operating terminal A 10, the operating terminal B 20, and the operating terminal C 30). In accord with linking and retrieving data provided by the user, the system 100 links to a distant server (e.g. the distant server A 15, the distant server B 25, and the distant server C 35) and extract the corresponding original website content (step 300). The user then performs editing and settings through the editing module 110 (including conversion pattern settings and editing rule settings) for the website conversion system 100 to make the corresponding conversion operations (step 400). The detailed steps are represented by step A to be described later. After all website conversion operations are done, the converted website contents are stored accordingly (step 500). This concludes the website conversion process.

In step A, the system displays the retrieved original website content in an editing window (step 410). The user selects an editing form (e.g. website structure conversion or web page content conversion) to be preformed (step 420). Suppose the user selects the website structure conversion (step 430), the process enters step C to be described later. If the user selects the web page content conversion (step 440), the system provides a menu for the user to determine the original web page to be converted, the web page content pattern to be applied, and the editing rules to be used (step 441). After the user finishes the selection, the system then perform the corresponding conversion operations on the original web page (step 442). The converted website content is displayed in the editing window for the user to make other editing (step 443). During the editing process, the system determines whether the user has completed the editing (step 444). If unfinished, the system stays in step 443 for the user to perform subsequent editing. Otherwise, if the user has completed editing, the system stores the converted website content (step 450) and asks whether the user wants to continue with other conversion operations (step 460). If the user answers yes, then the system returns to step 420 for the user to select an editing form. If the user answers no, the system enters step B (i.e. step 500) to store the converted website content. This then concludes the web page content conversion.

When the user selects to perform website structure conversion (step 430), the system enters step C. The system provides the user with website structure patterns for selection (step 431). After the selection, the system provides the user with an original web page corresponding to each content item chosen by the user because the website structure pattern contains links to many different content items (step 432). It further allows the user to design the web page content pattern to be used in the original web page and the allowed editing rules (step 433). Each time a content item setting is completed, the system automatically determines whether all content item settings are done (step 434). If not yet finished, the system returns to step 432 for the user to set other content items. Once finished, the system starts to execute the corresponding conversion operations of each original web page in the website structure (step 435). During the conversion process, the system also determines whether all conversions are successfully finished (step 436). If they are not completely done, the system goes back to step 435 to continue the conversions; otherwise, the system displays the converted website content for the user to make further modifications (step 437). Before the user finishes the editing, the system stays at step 437. Once the user finishes the editing, the system enters step D and stores all converted website contents (step 450). Afterwards, the system asks the user whether to continue with other conversion operations (step 460). If the user answers yes, the system returns to step 420 for the user to select an editing form. If the user does not have further editing, then the procedure enters step B (i.e. step 500), saving the converted website contents and finishing the website structure conversion.

### EFFECTS OF THE INVENTION

The disclosed on-line system for website transforming and method thereof use predetermined website and web page patterns and editing rules for the user to conveniently and efficiently convert the original website contents to desired ones. The converted website is not only good in easy future management and maintenance, it further enjoys the services of varieties of patterns. This additional advantage makes the website more flexible and extensible and, therefore, the provided network services more competitive.

What is claimed is:

1. An on-line system for website transforming for a user to use predetermined patterns and rules to perform conversions for website contents, the system comprising:
a plurality of operating terminals, each of which provides a browser for the user to link and enter the website conversion system for performing operations;
a plurality of distant servers, which stores original website contents and provides the associated World Wide Web (WWW) network services; and
a website conversion system, which includes:
a linking and retrieving module, which links to each of the distant servers according to a linking and retrieving datum provided by the user to retrieve the corresponding original website content;
a conversion pattern module, which provides a plurality of conversion patterns for website and web page content conversions and allows the extension of the patterns;
a conversion rule module, which provides a plurality of editing rules for website and web page content conversions and allows the extension of the rules;
an editing module, which generates an editing window for the user to select an editing form and the original website content, one of the conversion patterns, and a set of the editing rules in order to perform conversion operations; and
a website contents database, which stores converted website contents;
wherein each of the operating terminals is associated with one of the distant servers, or the operating terminals and the distant servers are independent.

2. The system of claim 1, wherein the website conversion system further includes a login verification module that executes a login verification procedure toward the user.

3. The system of claim 1, wherein the linking and retrieving datum consists of an authorization datum and a directory path datum.

4. The system of claim 1, wherein the conversion pattern includes a website structure pattern and a web page content pattern.

5. The system of claim 1, wherein the editing rules include conversion processing rules for texts, pictures and tables.

6. The system of claim 1, wherein the editing forms includes a website structure conversion and a web page content conversion.

7. An on-line method for website transforming for a user to use predetermined patterns and rules to perform conversions for website contents, the method comprising the steps of:
enabling the user to link and enter the website conversion system through a login verification procedure;
extracting an original website content through a linking and retrieving datum;
executing conversion operations according to an editing setting; and
storing a converted website content according to the user's request.

8. The method of claim 7, wherein the linking and retrieving datum consists of an authorization datum and a directory path datum.

9. The method of claim 7, wherein the editing setting includes a conversion pattern and an editing rule setting.

10. The method of claim 7, wherein the conversion pattern includes a website structure pattern and a web page content pattern.

11. The method of claim 7, wherein the editing rules include conversion processing rules for texts, pictures and tables.

12. The method of claim 7, wherein the step of executing conversion operations according to an editing setting further comprises the steps of:
displaying the original website content in an editing window;
selecting an editing form;
executing conversion operations specified in the editing form; and
storing the edited result.

13. The method of claim 12, wherein the editing forms include a website a website structure conversion and a web page content conversion.

14. The method of claim 13, wherein the website structure conversion comprises the steps of:
selecting a website structure pattern to be applied;
selecting an original web page corresponding to a content item;
setting the web page content pattern and the editing setting content;
executing the corresponding conversion operations in each of the original web pages;
displaying the converted website content for the user to make modifications; and completing editing.

15. The method of claim 13, wherein the web page content conversion comprises the steps of:
selecting an original web page to be converted, a web page content pattern, and the editing setting content;
executing the corresponding conversion operations in the original web page;
displaying the converted website content in the editing window for the user to make modifications; and
completing editing.
